(19) United States
(12) Patent Application Publication
(10) Pub. No.: US 2004/0017874 A1
(43) Pub. Date: Jan. 29, 2004

(54) Modulated quantum neutron fusion

(76) Inventors: Matthew William Gray, Sacramento, CA (US); William Thomas Gray, Ione, CA (US)

Correspondence Address: Matthew William Gray, P.O. Box 2165, Sacramento, CA, 95812-2165, US

(21) Appl. No.: 10/206,216

(22) Filed: Jul. 29, 2002

(51) Int. Cl. G21J 1/00; G21B 1/00

(52) U.S. Cl. 376/100

(57) ABSTRACT

The patent applied for in this application pertains to the production of neutrons by the excitation of hydrogen atom valence electrons to the quantum state of a neutron, the synchronization of the quantity and rate of the production of those neutrons in order to synchronize their half-life decays for use in a fusion reaction, the use of phase alignment of the particle field oscillations to precipitate nuclear binding in a fusion reaction, and the direct conversion of the energy from this process into electricity, along with the synthesis of other desired elements and decontamination of hazardous radioactive elements.

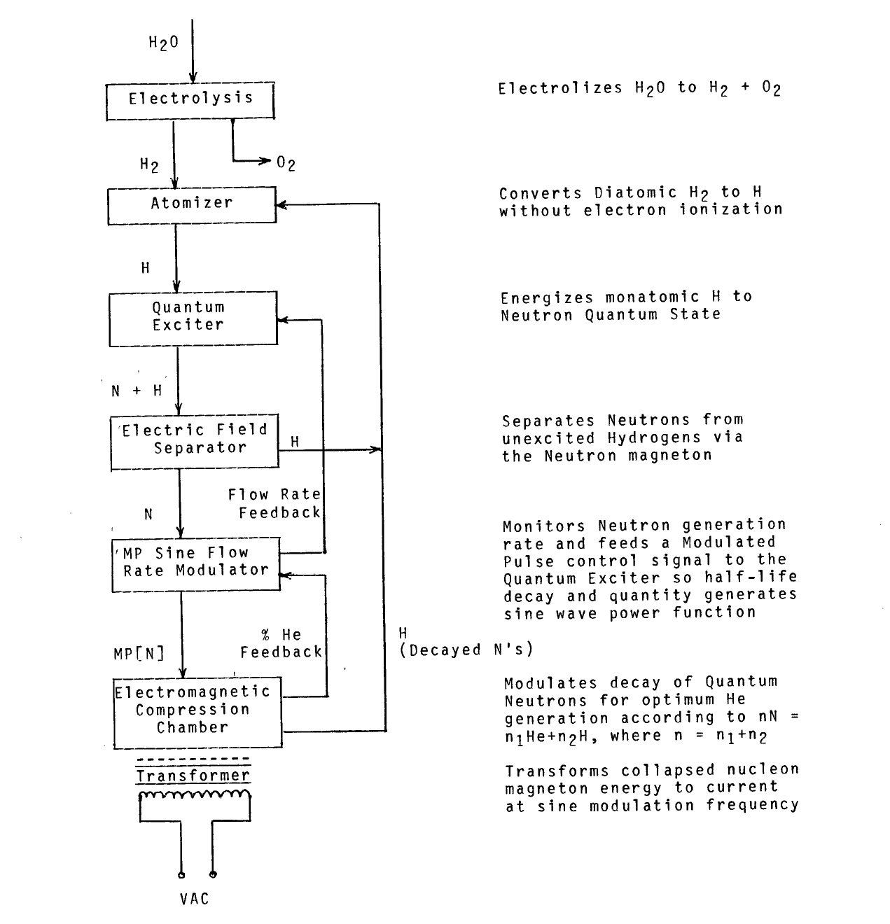

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention pertains to the controlled release of energy by the fusion of hydrogen into helium. Current state of technology has unsuccessfully attempted to achieve a controlled and sustained hydrogen into helium fusion process using deuterium and tritium because of the strong Coulomb forces between protons at the close proximities required for nuclear binding.

The Modulated Quantum Neutron Fusion process described herein overcomes this problem by utilizing the decay properties of neutrons to form a two proton two neutron helium nucleus from four neutrons. In footnote 26 of The Superposition States of Planck's Constant (attached) the correct value of the neutron magneton is calculated by showing that neutrons are quantum states of hydrogen atoms. This principle is utilized to control timing and quantity of neutron generation in a manner such that neutrons held in close proximity undergo half-life decay to helium nuclei with release of magnetic energy according to sine wave power curve.

### BRIEF SUMMARY OF THE INVENTION

Neutron half-lifes are in the order of 920 seconds when in freestanding configurations but vary significantly according to conditions when bound in nuclear configurations. As described in footnote 27 of The Superposition States of Planck's Constant the correct magnetic moment of stable deuterium nuclei is calculated by showing that a neutron, as a quantum hydrogen state, forms a stable resonant proton-electron-proton (pep) structure similar to the resonant delocalization in conjugated molecular structures.

In helium isotopes of atomic masses 5 and 7 however, the additional neutrons, incapable of forming stable pep structures, either eject a neutron in 2×10⁻²¹ s to form a stable pep:pep resonant helium structure of atomic mass 4 or decay a neutron in 60×10⁻⁶ s to form stable lithium with atomic mass 7. However, atomic mass 6 helium, with 2 extra neutrons capable of decaying to a stable pep structure, decays to stable mass 6 lithium in 0.79 s. This neutron decay rate behavior and relative reactant and product abundances in light nucleides indicates a stability and formation pattern based on their binding energy to mass ratios.

Since mass 4 helium has the highest binding energy to mass ratio of all nucleides (i.e. energy released on formation) it will be the predominate formation structure for neutrons of close proximity decaying into pep structures, as indicated by being the predominate product in uncontrolled fusion reactions. Also, since calculation on the neutron magneton and deuterium magnetic moment indicate that the resultant magnetic moment of nucleides represent their relative binding energy state, the formation energy of four neutrons decaying into a stable helium will yield a large magnetic flux change as the neutron magneton transitions from −1.9135, to a proton magneton of 2.7928, to a pep magnetic moment of 0.857, to a neutral helium magnetic moment, which can be transformed directly into electric current with minimum thermal energy losses.

The process described here generates monatomic hydrogen, excites them to a neutron quantum state, modulates their rate and quantity in a pulse pattern which integrates to a sine wave, and electromagnetically compresses the neutron pulses so the half-life decay results in two neutron two proton pep:pep helium nuclei with a release of magnetic energy to generate electricity.

### BRIEF DESCRIPTION OF THE DRAWING

The drawing shows a complete Modulated Quantum Neutron Fusion energy generation process. The Electrolysis unit converts water into diatomic hydrogen. The Atomizer adds 436 kJ/mole of thermal energy to convert diatomic into monatomic hydrogen. The Quantum Exciter then adds 0.782 MeV of electromagnetic energy to excite the valence electrons to the neutron quantum state. The Electric Field Separator uses moving magnetic fields to accelerate the particles and an electric field to impart an angular momentum to them. Since the neutron magneton is not linearly proportional to its mass it is separated from the hydrogen atoms.

The Modulated Pulse Sine Flow Rate Modulator monitors the ratio of helium produced to reactant neutrons and generates control pulses to the Quantum Exciter to regulate frequency and quantity of neutrons produced so that the half-life decay reaction produces helium, and thus a changing magnetic field, according to the desired sine wave frequency. The Electromagnetic Compression Chamber uses Electric Field Separator principles to compress the neutrons to less than 1.4×10⁻¹⁵ m separation and align their phases to increase the decay rate and cause constructive interference of their fields resulting in particle fusion. The Transformer uses the collapsing magneton field energy to generate electricity.

### DETAILED DESCRIPTION OF THE INVENTION

This invention makes use of the neutral charge and half life decay characteristics of neutrons to eliminate Coulomb force repulsions associated with protons and create conditions conducive to particle fusion. It utilizes the principles developed in “The Superposition States of Planck's Constant” paper by W. T. Gray to generate modulated quantum neutrons to precipitate fusion. The values of proton and neutron magnetons were correctly calculated (footnotes 25 & 26) by showing that the electromagnetic fields are a 32 resultant of a 3-dimensional energy oscillation in terms of E=hf, E=mE²/B², and an energy density based on the particle size to field strength ratio, and that a neutron is a quantum hydrogen state with 1.257×10⁻¹⁴ m electron wavelength and 0.782 MeV energy.

The paper also shows that the nuclear binding force is a quantum superposition state of the waves that generate particle's electromagnetic fields (footnote 27) and that the superpositioning occurs when particles are within 212 times the field oscillation's ½ wavelength of 1×10⁻¹⁵ m for particles of 2×10⁻¹⁵ m diameter. Since neutrons have no external charge, and no Coulomb force repulsion, a neutron will decay into a proton-electron-proton resonance state with another neutron as long as the field oscillation phases of the protons align so superpositioning can occur and the resultant E²/B² fields reinforce instead of interfere. Since neutron decay rate depends on proximity and relative stability of the reactant and product configurations the predominant product will be He.

To achieve this objective water is Electrolyzed to H₂ and then Atomized to monatomic H by the addition of 436 kJ/mole of thermal energy. Monatomic hydrogen electrons are then excited to an energy of 0.782 MeV and wavelength of 1.257×10⁻¹⁴ m by either radio frequency of light energy. Although this energy exceeds the 13.6 eV ionization energy of hydrogen the desired state is allowed by Schroedinger's electron position probability relation where |Ψ|² is actually ΨΨ* and the hydrogen 0 state is an energy well between boundary conditions of ionization, with orbitals represented by Ψ, and the neutron state, with orbitals represented by Ψ*.

A neutron-hydrogen mixture from the Quantum Exciter is passed to the Electric Field Separator using a travelling magnetic field, as in induction motor stator coils to the rotor coils, to accelerate the particles by their magnetic moments and pass them to an electric field to impart angular momentum and separate them. Hydrogens are returned to the Exciter and neutrons are passed to the Modulated Pulse Sine Flow Rate Modulator which monitors the He to neutron ratio and generates a frequency modulated pulse train, the repetition rate of which varies with the desired power output sine wave. The resultant frequency modulated pulses of neutrons are passed to the Electromagnetic Compression Chamber.

The Electromagnetic Compression Chamber has 2 functions, compression of neutrons in a pulse to within 1.414×10⁻¹⁵ m and the alignment of the field oscillations of their constituent protons so superpositioning occurs. Since neutrons have no charge their compression to the desired density is achieved by the principles used in the Field Separator. The phase alignment is accomplished be repeatedly subjecting a pulse of neutrons to compression as it is accelerated. The repeated application of the electromagnetic compression fields will equalize their velocities and alignments. A toroidal acceleration chamber is best suited for this. Velocity must be maintained at subrelativistic speeds so as to prevent time dilation delay in the decay of the neutrons into He.

Because the repetition rate and velocity of the neutron pulses injected into the Electromagnetic Compression Chamber are controlled, their velocity can be adjusted so neutron decay occurs in the vicinity of a transformer coil. The decay and collapse into a He stable state results in release of energy that was manifested as the reactant particle magnetons. The transformer coil absorbs this energy and transforms it into an electric current. Otherwise the released energy must be absorbed thermally and converted to a useful form by conventional power conversion processes.

The Quantum Neutron decay reaction is only statistically controllable so there will be side product reactions. The reaction control parameters (i.e. quantity of neutrons in pulses, neutron density, and delay in half-life decay) can be used to adjust the yield of He or desired side products, if that is the goal. Since some by-products will be potentially radioactive and hazardous, they can be separated out and subjected to bombardment by neutron pulses in order to transmute them into non-radioactive compounds.

Advantages of this method of fusion over existing ones is that it relies on the controlled generation of quantum neutrons with synchronized half-life decays and overcomes all the problems associated the Coulomb force repulsions of the protons in tritium, deuterium, or independent proton injection. Phase alignment of the particle field oscillations is used to precipitate the nuclear binding forces of a He stable state. It allows for extraction of energy directly without thermal losses of conventional generation processes. And it makes possible generation of other desirable products and elimination of undesirable radioactive by-products.

1: What we claim as our invention is the aforementioned process of exciting hydrogen atom valence electrons to a quantum state by radio frequency, light energy, or other synthetic means, that results in artificial production of neutrons.

2: What we claim as our invention is the aforementioned process of modulating the production of neutrons by the method in claim 1 so as to synchronize their quantity and half-life decays to precipitate a nuclear fusion reaction of neutrons into Helium.

3: What we claim as our invention is the aforementioned process of aligning the field oscillation phases of particles in order to precipitate nuclear binding in fusion reactions.

4: What we claim as our invention is the aforementioned method of converting the magnetic energy from the Modulated Quantum Neutron Fusion process directly into electricity.

5: What we claim as our invention is the aforementioned application of using the neutrons produced by the method in claim 1 to synthesize elements.

6: What we claim as our invention is the aforementioned application of using the neutrons produced by the method in claim 1 to decontaminate hazardous radioactive materials and substances so as to render them non-radioactive.
